(19) United States
(12) Patent Application Publication
(10) Pub. No.: US 2016/0260157 A1
(43) Pub. Date: Sep. 8, 2016

(54) RAPID SERVICE ORCHESTRATION AND MANAGEMENT

(71) Applicant: International Business Machines Corporation, Armonk, NY (US)

(72) Inventors: Daniel C. Krook, Fairfield, CT (US); John H. Teoh, Naperville, IL (US); Dominique Vernier, Tampa, FL (US)

(21) Appl. No.: 14/639,174

(22) Filed: Mar. 5, 2015

(51) Int. Cl. G06Q 30/06; H04L 29/08

(52) U.S. Cl. CPC G06Q 30/0635; H04L 67/10; H04L 67/306; H04L 67/16

(57) ABSTRACT

An approach for managing services in a cloud computing service marketplace. In the approach, a request for a service offered within a cloud computing service marketplace is received. A processor validates the request to confirm the service is offered within the cloud computing service marketplace. A processor applies a marker for the request, wherein the marker enables the request to be tracked. A processor validates the request to confirm that a sender of the request corresponds to a user account. A processor selects a handler from a set of one or more handlers to execute the request based on the request for the service and the service being offered by the cloud computing service marketplace, wherein the handler is capable of executing a business logic technique. A processor executes the business logic technique for the request using the handler.

### TECHNICAL FIELD

The present invention relates generally to the field of provisioning and management in a cloud marketplace and more particularly to creating a standard and secure method of presenting products to consumers.

### BACKGROUND

Cloud computing is a computing environment in which large groups of remote servers are networked to allow centralized data storage and online access to computer services or resources. Cloud networks can be classified as public, private, or a hybrid of the two. Cloud services are services made available to users on demand via the Internet from a cloud computing provider's servers, as opposed to services that are provided from end user's private servers. Cloud services are designed to provide easy, scalable access to applications, resources, and serves, and are fully managed by a cloud service provider. A cloud service provider can fluctuate in size based on the needs of the cloud service provider's users and the resources available from the cloud service provider.

Cloud service providers offer services within a cloud environment. Typically, cloud services are designed to provide easy, scalable access to applications, resources and services and are fully managed by a cloud service provider. Cloud service providers are responsible for implementing the service within the cloud environment and also for managing their services within the cloud marketplace. A cloud marketplace is a virtual store front operated by a cloud service provider. The cloud service provider's applications can be built on, integrated into, or complement the cloud service provider's main infrastructure or platform. Users may have the option to subscribe to these applications. A cloud marketplace typically provides users with native cloud applications and approved apps created by third party developers.

### SUMMARY

In one aspect, the present invention provides a method for managing services in a cloud computing service marketplace. The method includes receiving a request for a service offered within a cloud computing service marketplace. The method further includes validating the request to confirm the service is offered within the cloud computing service marketplace. The method further includes applying a marker to the request, wherein the marker enables the request to be tracked. The method further includes validating the request to confirm that a sender of the request corresponds to a user account. The method further includes selecting a handler from a set of one or more handlers to execute the request based on the request for the service and the service being offered by the cloud computing service marketplace, wherein the handler is capable of executing a business logic technique. The method further includes executing the business logic technique for the request using the handler.

In another aspect, the present invention provides a computer program product for managing services in a cloud computing service marketplace. The computer program product includes one or more computer readable storage media and program instructions stored on the one or more computer readable storage media. The program instructions include program instructions to receive a request for a service offered within a cloud computing service marketplace. The program instructions further include program instructions to validate the request to confirm the service is offered within the cloud computing service marketplace. The program instructions further include program instructions to apply a marker to the request, wherein the marker enables the request to be tracked. The program instructions further include program instructions to validate the request to confirm that a sender of the request corresponds to a user account. The program instructions further include program instructions to select a handler from a set of one or more handlers to execute the request based on the request for the service and the service being offered by the cloud computing service marketplace, wherein the handler is capable of executing a business logic technique. The program instructions further include program instructions to execute the business logic technique for the request using the handler.

In yet another aspect, the present invention provides a computer system for managing services in a cloud computing service marketplace. The computer system includes one or more computer processors, one or more computer readable storage media, and program instructions stored on the computer readable storage media for execution by at least one of the one or more processors. The program instructions include program instructions to receive a request for a service offered within a cloud computing service marketplace. The program instructions further include program instructions to validate the request to confirm the service is offered within the cloud computing service marketplace. The program instructions further include program instructions to apply a marker to the request, wherein the marker enables the request to be tracked. The program instructions further include program instructions to validate the request to confirm that a sender of the request corresponds to a user account. The program instructions further include program instructions to select a handler from a set of one or more handlers to execute the request based on the request for the service and the service being offered by the cloud computing service marketplace, wherein the handler is capable of executing a business logic technique. The program instructions further include program instructions to execute the business logic technique for the request using the handler.

In yet another aspect, the present invention provides a method for assisting a user with a service request, comprising: receiving a request for a service offered within a cloud computing service marketplace; validating the request to confirm the service is offered within the cloud computing service marketplace; applying a marker to the request, wherein the marker enables to request the be tracked; validating the request to confirm that a sender of the request corresponds to a user account; selecting a handler from a set of one or more handlers to execute the request based on the request for the service and the service being offered by the cloud computing service marketplace, wherein the handler is capable of executing a business logic technique; executing the business logic technique for the request using the handler.

### BRIEF DESCRIPTION OF THE DRAWINGS

FIG. 1 is a block diagram of a cloud computing node according to an embodiment of the present invention.

FIG. 2 is a block diagram of a cloud computing environment according to an embodiment of the present invention.

FIG. 3 is a depiction of an abstraction model layers according to an embodiment of the present invention.

FIG. 4 is a block diagram of a computing environment, in accordance with one embodiment of the present invention.

FIG. 5 is a flowchart depicting operational steps of a relevancy function, within the computing environment of FIG. 1, in accordance with one embodiment of the present invention.

FIG. 6 is a flowchart depicting operational steps of a handler executing the requested task, within the computing environment of FIG. 1, in accordance with one embodiment of the present invention.

### DETAILED DESCRIPTION

As will be appreciated by one skilled in the art, aspects of the present invention may be embodied as a program, method or computer program product. Accordingly, aspects of the present invention may receive the form of an entirely hardware embodiment, an entirely software embodiment (including firmware, resident software, micro-code, etc.) or an embodiment combining software and hardware aspects which generally be referred to herein as a “circuit,” “module” or “program.” Furthermore, aspects of the present invention may receive the form of a computer program product embodied in one or more computer-readable medium(s) having computer readable program code/instructions embodied thereon.

Embodiments of the present invention recognize that there are different methods in a cloud marketplace for orchestrating service provisioning and management for cloud service providers. However, there is a need for a standard method in cloud computing for orchestrating service provisioning and management for cloud service providers. Embodiments of the present invention add a standard method for orchestrating services provisioning and management in a cloud marketplace, by providing a systematic approach and a process to help service providers integrate their services into a cloud marketplace in a structured step by step manner. Additionally, embodiments of the present invention may reduce errors in integration as the present invention is fully tested with systematic step by step implementation processes.

Embodiments of the present invention disclose an approach to provide a standard process for service providers to integrate their services into a cloud marketplace.

The present invention will now be described in detail with reference to the Figures.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications executing on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and execute arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

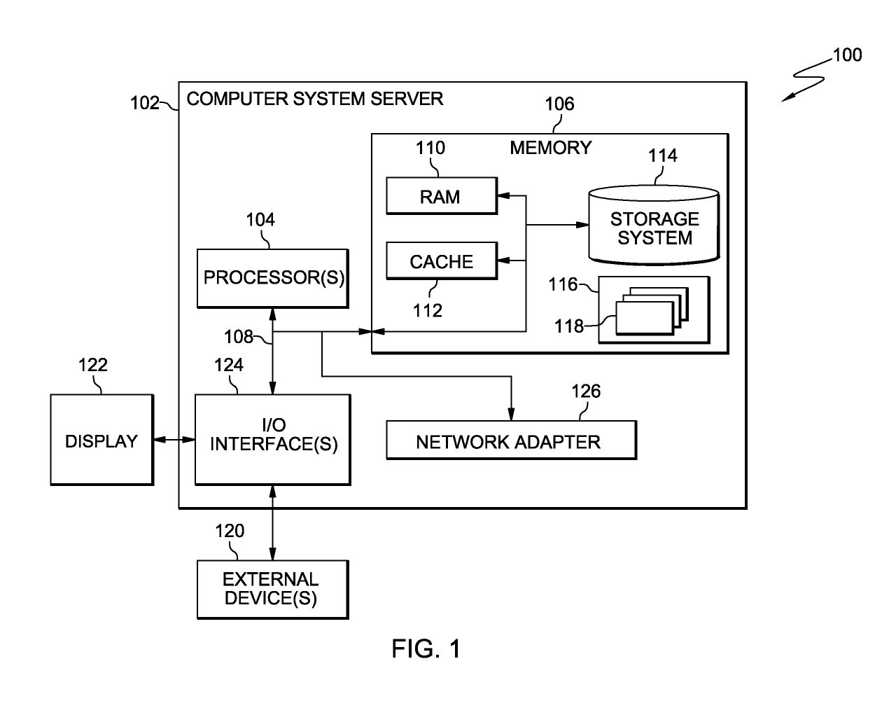

FIG. 1, a schematic of an example of a cloud computing node is shown. Cloud computing node 100 is only one example of a suitable cloud computing node and is not intended to suggest any limitation as to the scope of use or functionality of embodiments of the invention described herein. Regardless, cloud computing node 100 is capable of being implemented and/or performing any of the functionality set forth hereinabove.

In cloud computing node 100 there is a computer system/server 102, which is operational with numerous other general purpose or special purpose computing system environments or configurations. Examples of well-known computing systems, environments, and/or configurations that may be suitable for use with computer system/server 102 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 102 may be described in the general context of computer system executable instructions, such as program modules, being executed by a computer system. Generally, program modules may include routines, programs, objects, components, logic, data structures, and so on that perform particular tasks or implement particular abstract data types. Computer system/server 102 may be practiced in distributed cloud computing environments where tasks are performed by remote processing devices that are linked through a communications network. In a distributed cloud computing environment, program modules may be located in both local and remote computer system storage media including memory storage devices.

FIG. 1, computer system/server 102 in cloud computing node 100 is shown in the form of a general-purpose computing device. The components of computer system/server 102 may include, but are not limited to, one or more processors or processing units 102, a system memory 106, and a bus 108 that couples various system components including system memory 106 to processor(s) 104.

Bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 102 typically includes a variety of computer system readable media. Such media may be any available media that is accessible by computer system/server 102, and it includes both volatile and non-volatile media, removable and non-removable media.

System memory 106 can include computer system readable media in the form of volatile memory, such as random access memory (RAM) 110 and/or cache memory 112. Computer system/server 102 may further include other removable/non-removable, volatile/non-volatile computer system storage media. By way of example only, storage system 114 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 108 by one or more data media interfaces. As will be further depicted and described below, memory 106 may include at least one program product having a set (e.g., at least one) of program modules that are configured to carry out the functions of embodiments of the invention.

Program/utility 116, having a set (at least one) of program modules 118, may be stored in memory 106 by way of example, and not limitation, as well as an operating system, one or more application programs, other program modules, and program data. Each of the operating system, one or more application programs, other program modules, and program data or some combination thereof, may include an implementation of a networking environment. Program modules 118 generally carry out the functions and/or methodologies of embodiments of the invention as described herein.

Computer system/server 102 may also communicate with one or more external devices 120 such as a keyboard, a pointing device, a display 122, etc.; one or more devices that enable a user to interact with computer system/server 102; and/or any devices (e.g., network card, modem, etc.) that enable computer system/server 102 to communicate with one or more other computing devices. Such communication can occur via Input/output (I/O) interfaces 124. Still yet, computer system/server 102 can communicate with one or more networks such as a local area network (LAN), a general wide area network (WAN), and/or a public network (e.g., the Internet) via network adapter 126. As depicted, network adapter 126 communicates with the other components of computer system/server 102 via bus 108. It should be understood that although not shown, other hardware and/or software components could be used in conjunction with computer system/server 102. Examples, include, but are not limited to: microcode, device drivers, redundant processing units, and external disk drive arrays, RAID systems, tape drives, and data archival storage systems, etc.

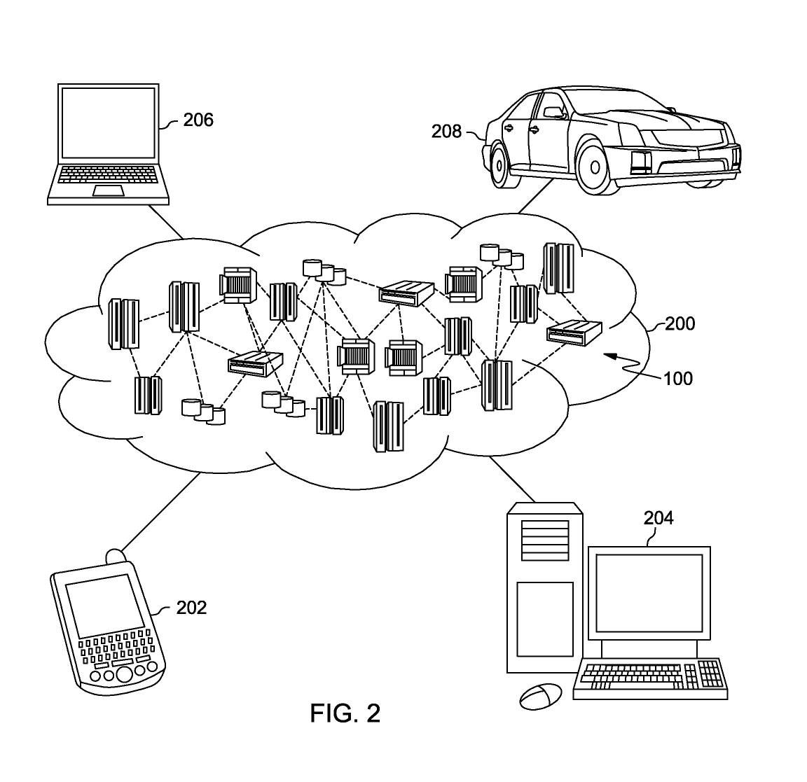

FIG. 2, illustrative cloud computing environment 200 is depicted. As shown, cloud computing environment 200 comprises one or more cloud computing nodes 100 with which local computing devices used by cloud consumers, such as, for example, personal digital assistant (PDA) or cellular telephone 202, desktop computer 204, laptop computer 206, and/or automobile computer system 208 may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 200 to offer infrastructure, platforms and/or software as services for which a cloud consumer does not need to maintain resources on a local computing device. It is understood that the types of computing devices 202, 204, 206, 208 shown in FIG. 2 are intended to be illustrative only and that computing nodes 100 and cloud computing environment 200 can communicate with any type of computerized device over any type of network and/or network addressable connection (e.g., using a web browser).

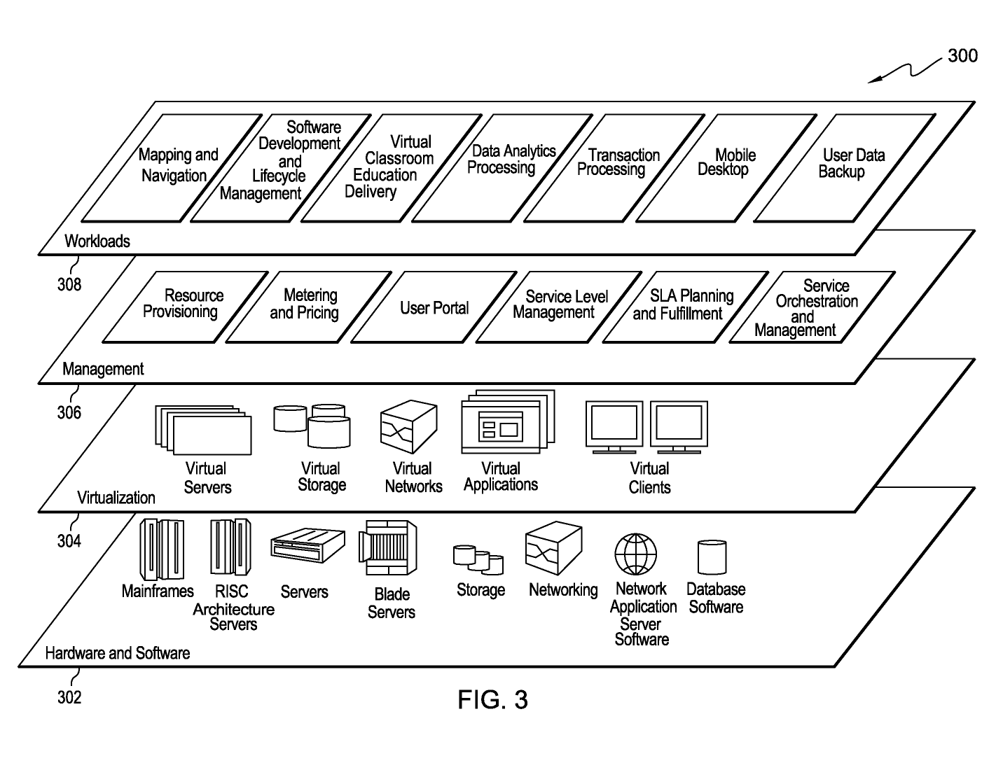

FIG. 3, a set of functional abstraction layers provided by cloud computing environment 200 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 302 includes hardware and software components. Examples of hardware components include: mainframes; RISC (Reduced Instruction Set Computer) architecture based servers; storage devices; networks and networking components. In some embodiments, software components include network application server software.

Virtualization layer 304 provides an abstraction layer from which the following examples of virtual entities may be provided: virtual servers; virtual storage; virtual networks, including virtual private networks; virtual applications and operating systems; and virtual clients.

In one example, management layer 306 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, procurement of, cloud computing resources for which a future requirement is anticipated in accordance with an SLA, and service orchestration and management provisions through management in a cloud marketplace.

Workloads layer 308 provides examples of functionality for which the cloud computing environment may be utilized. Examples of workloads and functions which may be provided from this layer include: mapping and navigation; software development and lifecycle management; virtual classroom education delivery; data analytics processing; transaction processing; mobile desktop; and user data backup.

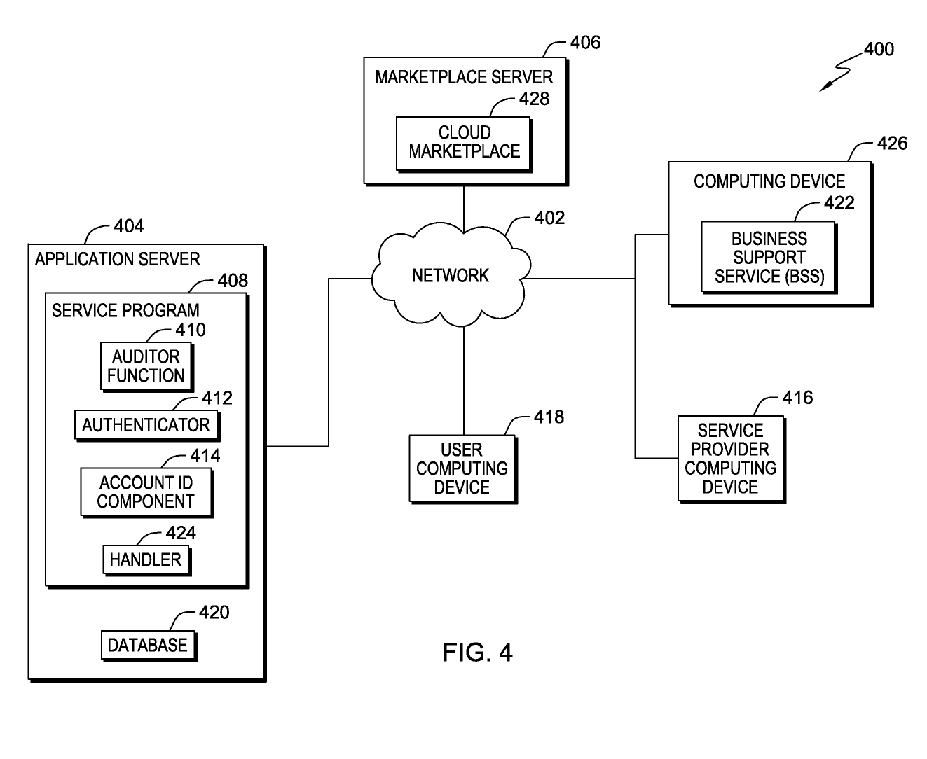

FIG. 4 is a block diagram of computing environment 400 in accordance with one embodiment of the present invention. FIG. 4 provides an illustration of one embodiment and does not imply any limitations regarding computing environment 400 in which different embodiments maybe implemented. In the depicted embodiment, computing environment 400 includes, but is not limited to, application server 404, marketplace server 406, service provider computing device 416, user computing device 418, and computing device 426 capable of communicating with each other via network 402. Computing environment 400 may include additional computing devices, servers, computers, components, or additional devices not shown.

Network 402 may be a local area network (LAN), a wide area network (WAN) such as the Internet, any combination thereof, or any combination of connections and protocols that support communications between application server 404, marketplace server 406, service provider computing device 416, user computing device 418, and computing device 426 in accordance with embodiments of the invention. Network 402 may include wired, wireless, or fiber optic connections.

Application server 404 may be a management server, a web server, or any additional electronic device or computing system capable of processing program instructions and receiving and sending data. In some embodiments, application server 404 may be a laptop computer, tablet computer, netbook computer, personal computer (PC), desktop computer, or any programmable electronic device capable of communicating with marketplace server 406, service provider computing device 416, user computing device 418, computing device 426 via network 402. In other embodiments, application server 404 may represent a server computing system utilizing multiple computers as a server system. In another embodiment, application server 404 represents a computing system utilizing clustered computers and components to act as a single pool of seamless resources. In the depicted embodiment, application server 404 includes service program 408 and database 420. In other embodiments, application server 404 may include other elements and components.

Service program 408 implements the integration of service provider's services within cloud marketplace 428 according to a step by step systematic approach and process. In one embodiment, service program 408 is a glue code which listens to cloud marketplace 428 user events, validates, authenticates and audits user computing device 418 requests prior to binding to the service requested via the handler 424 to keep track of the database 420 based on the account identifier generated. Glue code is computer code which unites programs or software components which would not be compatible otherwise. Glue code does not serve a purpose for computation or calculation, but serves exclusively as a proxy between two incompatible programs or software components. In one embodiment, service program 408 is implemented as a light-weight virtual machine hosted by service provider computing device 416. In one embodiment, service program 408 is a web application which executes on an application server 404. In other embodiments, service program 408 is a fully customizable application which can provide for service provider computing device 416 with service provider's own business logic at different stages of the request execution. In other embodiments, service program 408 can decide which database to use for auditing. In one embodiment, service program 408 can be used as a marketplace emulator application for Cloud marketplace 428 which allows service provider computing device 416 to test the implementation of Cloud marketplace 428 locally. In the depicted embodiment, service program 408 includes auditor function 410, authenticator 412, or account ID component 414 and handler 424. In other embodiments, service program 408 can be comprised of these and additional elements. In other embodiments, service program 408 may be located on another server or computing device, provided service program 408 marketplace server 406, computing device 426, service provider computing device 416, and/or user computing device 418.

Service program 408 listens to requests from the cloud marketplace 428 and dispatches requests after authenticator 412 authenticates the request. Service program 408 receives requests from cloud marketplace 428 and dispatches requests to necessary components within service program 408. In other embodiments, service program 408 provides a methodology to manage and monitor application environment based on policies and usage patterns to act within real-time or configurable deferred-time options to minimize business impact. The methodology effectively addresses operations, scalability and availability management.

Auditor function 410 records vital information for requests, so as requests are processed, the vital information can be accessible to the necessary components of service program 408, Business Support Service (BSS) 104, cloud infrastructure service 118, service provider computing device 416, and cloud marketplace 428. Auditor function 410 stores the information which auditor function 410 gathers in database 420. In other embodiments, auditor function 410 stores information in additional locations, so long as auditor function 410 can access the stored information via network 402. In one embodiment, auditor function 410 records the origin, time stamp, and status of request. In other embodiments, auditor function 410 records, but is not limited to recording, the origin, time stamp, status of request and additional pieces of information which is relevant to the request. In one embodiment, auditor function 410 periodically updates the requests at each stage of the process. In one embodiment, auditor function 410 updates the vital information for the request anytime the request is modified. In other embodiments, auditor function 410 only records the vital information for the request when the request is initially received by auditor function 410. In the depicted embodiment, auditor function 410 is located within service program 408. In other embodiments, auditor function 410 may stand alone as a program located on server 404, user computing device 418, service provider computing device 416, computing device 426, marketplace server 406, or any additional computing device, provided auditor function 410 is accessible to service program 408.

Authenticator 412 checks authorizations and/or authentications for requests. In one embodiment, the authorization and/or authentication is provided by service provider computing device 416, and authenticator 412 compares the authorization and/or authentication of service provider computing device 416 to what was received from cloud marketplace 428. Authenticator 412 authenticates the request to maintain a high level of security between service provider computing device 416, cloud marketplace 428, and cloud infrastructure service 118. In one embodiment, authenticator 412 receives the request from service program 408 and authenticates and/or authorizes the request as a security measure. In one embodiment, authenticator 412 validates the user request with consumer passwords or additional methods of authenticating which user is the correct user. In other embodiments, authenticator 412 receives the request from cloud marketplace 428 and authenticates and/or authorizes the request. In the depicted embodiment, authenticator 412 is located within service program 408. In other embodiments, auditor function 410 may stand alone as a program located on server 404, user computing device 418, service provider computing device 416, computing device 426, marketplace server 406, or any additional computing device, provided authenticator 412 is accessible to service program 408.

Account ID component 414 generates a unique account ID for each service request, or subscription which is created, and stores each service requesting database 420. In other embodiments Account ID component 414 stores this information on another storage device, so long as Account ID component 414 utilizes access to the stored information via network 402. As service program 408 deals with one or more subscriptions per user, the unique account ID is used to identify a particular service. Account ID component 414 keeps track and manages the resources used to provide the service to the user. In the depicted embodiment, account ID component 414 communicates with handler 424. In one embodiment, Account ID component 414 provides a transaction tracking number to link requests together. In the depicted embodiment, account ID component 414 is located within service program 408. In other embodiments, auditor function 410 may stand alone as a program located on server 404, user computing device 418, service provider computing device 416, computing device 426, marketplace server 406, or any additional computing device, provided account ID component 414 is accessible to service program 408.

Handler 424 executes the request from service program 408. Handler 424 retrieves information from account ID component 414, auditor function 410, and/or authenticator 412 to understand how the request is to be executed. In one embodiment, service provider 408 utilizes the opportunity to execute custom code/script before and after the deployment of the request. In one embodiment, handler 424 validates the request, if the request does not pass the validation process, an error message is returned to service program 408 as a response for the request, if the validation process does not produce an error message the process continues. In the depicted embodiment, handler 424 is located within service program 408. In other embodiments, auditor function 410 may stand alone as a program located on server 404, user computing device 418, service provider computing device 416, computing device 426, marketplace server 406, or any additional computing device, provided handler 424 is accessible to service program 408.

In several embodiments, handler 424 can perform different operations including, but not limited to, an order subscription, change subscription, cancel subscription, notice subscription, order add-on, change add-on, bind add-on, unbind add-on, cancel add-on, assignment user, and unassignment user. In other embodiments, order subscription handler is divided into order subscription soft layer handler, order subscription cloudify (transition on-site services to cloud based services) handler, or order subscription cloud foundry handler. In a further embodiment, cancel subscription handler is divided into cancel subscription soft layer handler, cancel subscription cloudify handler, and cancel subscription cloud foundry handler.

Marketplace server 406 may be a management server, a web server, or any additional electronic device or computing system capable of processing program instructions and receiving and sending data. In some embodiments, marketplace server 406 may be a laptop computer, tablet computer, netbook computer, personal computer (PC), desktop computer, or any programmable electronic device capable of communicating with application server 404, service provider computing device 416, user computing device 418, computing device 426 via network 402. In other embodiments, marketplace server 406 may represent a server computing system utilizing multiple computers as a server system. In another embodiment, marketplace server 406 represents a computing system utilizing clustered computers and components to act as a single pool of seamless resources. In the depicted embodiment, cloud marketplace 428 resides on marketplace server 406. In other embodiments, marketplace server 406 may include additional elements or components.

Cloud marketplace 428 is an online store designed to help people and organizations discover, purchase, and deploy goods, services, and products in a cloud web based program. Cloud marketplace 428 is operated by a cloud provider, through which a user may subscribe to applications which are built on, integrated with, or complement the cloud provider's main infrastructure, platform or software service. In one embodiment, cloud marketplace 428 provides users with native cloud applications and approved apps created by third party developers. In other embodiments, cloud marketplace 428 provides applications only by the cloud service provider.

Service provider computing device 416 may be a desktop computer, laptop computer, tablet computer, netbook computer, personal computer (PC), desktop computer, mobile device, or any programmable electronic device capable of communicating with application server 404, marketplace server 406, user computing device 418, and computing device 426 via network 102. In other embodiments, service provider computing device 416 may be any electronic device or computing system capable of sending and receiving data and communicating with application server 404, marketplace server 406, user computing device 418, and computing device 426 via network 102. In the depicted embodiment, service provider computing device 416 is a computing device on which the service provider may access cloud marketplace 428 and/or receive software and applications from cloud marketplace 428. Service provider computing device 416 is a device managed by the service provider to maintain, manage, and/or control the content which the service provider makes available to users via cloud marketplace 428. In other embodiments, service provider computing device 416 is a device which the service provider uses for consulting, legal, real estate, education, communication, storage, processing and/or many additional services. In one embodiment, service provider computing device 416 can be an internal device used by the service provider, a shared device among many service providers, or an external device used by the service provider.

User computing device 418 may be a desktop computer, laptop computer, tablet computer, netbook computer, personal computer (PC), desktop computer, mobile device, or any programmable electronic device capable of communicating with application server 404, marketplace server 406, service provider computing device 416, and computing device 426 via network 102. In other embodiments, user computing device 418 may be any electronic device or computing system capable of sending and receiving data and communicating with application server 404, marketplace server 406, service provider computing device 416, user computing device 418, and computing device 426 via network 102. In the depicted embodiment, user computing device 418 is a computing device on which a user may access cloud marketplace 428 and/or receive software and applications from cloud marketplace 428.

Computing device 426 may be a desktop computer, laptop computer, tablet computer, netbook computer, personal computer (PC), desktop computer, mobile device, or any programmable electronic device capable of communicating with application server 404, marketplace server 406, service provider computing device 416, and user computing device 418 via network 102. In other embodiments, computing device 426 may be any electronic device or computing system capable of sending and receiving data and communicating with application server 404, marketplace server 406, service provider computing device 416, and user computing device 418 via network 102. In the depicted embodiment, computing device 426 is a computing device on which BSS 422 resides. In other embodiments, computing device 426 can include additional components.

BSS 422 receives orders, payment issues, revenues, invoices, and additional forms of order, money, revenue, product, and user management. In one embodiment, BSS 422 communicates with service program 408. In the depicted embodiment, BSS 422 is located on computing device 426, and connected to application server 404, marketplace server 406, service provider computing device 416, and user computing device 418 via network 402. In other embodiments, BSS 422 is located on another computing device or server provided BSS 422 communicates with application server 404, marketplace server 406, service provider computing device 416, and user computing device 418 via network 402. In one embodiment, BSS 422 is a product management program, BSS 422 supports product development, sales and management of products, offers and bundles to business and users, cross-product discounts, appropriate pricing and managing how products related to one another. In another embodiment, BSS 422 is a user management service, capable of covering requirements for partner management and managing user relationships to help user care agents handle users in a better more informed manner. In another embodiment, BSS 422 is a revenue management program, BSS 422 focuses on billing, charging, and settlement. In another embodiment, BSS 422 is an order management program, BSS 422 decompresses sales orders into multiple work or service orders, can orchestrate order management across multiple fulfillment and order capturing networks. BSS 422 sorts out and determines order failures or order errors, and manage order status throughout the entire process from the order being placed until the goods or service are delivered or rendered to user computing device 418.

Database 420 may be a repository which may be written to and/or read by service program 408, auditor function 410, authenticator 412, or account ID component 414. Information gathered by service program 408, auditor function 410, authenticator 412, or account ID component 414 may be stored to database 420. In one embodiment, database 420 is a database management system (DBMS) used to allow the definition, creation, querying, update, and administration of a database(s). In the depicted embodiment, database 420 is connected to network 402. In other embodiments, database 420 may resides on a server, or another computing device, provided database 420 is accessible to service program 408, BBS computing device 422, and service provider computing device 416.

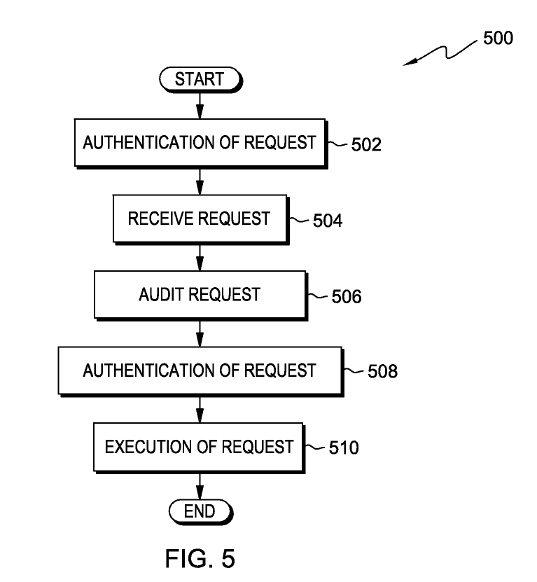

FIG. 5 depicts a flowchart 500 of the steps of service program 408 executing a request for a service within computing environment 100 of FIG. 1, in accordance with an embodiment of the present invention. Flowchart 500 depicts the receiving, sending and implementation of a request for a service from user computing device 418 to the service program 408.

In step 502, service program 408 authenticates a request from cloud marketplace 428. User computing device 418 requests a service, product, or goods available from cloud marketplace 428, the services, products, or goods are provided by service provider computing device 416. Cloud marketplace 428 communicates with both service provider computing device 416, to confirm the service, product, or goods are available and accessible, as well as service program 408, to confirm the request is authentic. Authenticator 412 verifies the request is authentic and can be executed. In one embodiment, authenticator 412 uses OAuth implementation to verify the request. OAuth is an open standard for authorization. OAuth provides client applications a ‘secure delegated access’ to server resources on behalf of a resource owner. It specifies a process for resource owners to authorize third-party access to their server resources without sharing their credentials. In other embodiments, authenticator 412 uses additional methods to verify the request. In one embodiment, if the request cannot be authenticated by authenticator 412, authenticator 412 reports the issue to service provider computing device 416.

In step 504, service program 408 receives the request from cloud marketplace 428. Service program 408 assess the details of the request to determine the necessary steps required to execute the request. Service program 408 may determine the user sending the request, the service provider the request is intended for, or the requirements of the request. In one embodiment, account ID component generates a unique account ID when service program 408 receives the request. The unique account ID for the request may include the details regarding the request, which are provided from cloud marketplace 428 and service provider computing device 416. The account ID is used to distinguish the numerous requests which are received by service program 408. In one embodiment, account ID component 414 gathers details from additional locations and sources which can include but are not limited to cloud marketplace 428 and service provider computing device 416 to create the account ID for the request. In one embodiment, Account ID component 414 applies an account ID to request received by service program 408. In other embodiments, account ID component 414 only applies an account ID to requests which are properly authenticated by authenticator 412.

In one embodiment, a user generates a request from user computing device 418 from a catalog presented to the user in cloud marketplace 428. In one embodiment, the catalog includes available cloud service offerings from service provider computing device 416. In one embodiment, the catalog of available cloud services includes predefined common micro services which are presented as static images, blue prints, or recipes to user computing device 418 to assist in the selection process for services, goods, or products user might purchase. In other embodiments, the catalog is a pre-configured catalog of service definitions, such as operating system images and declarative service roles.

In step 506, service program 408 audits the request. In one embodiment, service program 408 sends the request to auditor function 410. Upon receiving the request, auditor function 410 may apply different markers to the request including, but not limited to, a time stamp, an origin of the request, and status report of the request. Auditor function 410 applies different markers to track the request. The different markers track the request if an issue arises or a modification needs to be made to the request. In one embodiment, service program 408 initially sends the request to auditor function 410 to apply the different markers to the request. In other embodiments, auditor function 410 periodically sends one or more requests to update the markers. In other embodiments, auditor function 410 applies markers only when receiving a request from service program 408, handler 424, authenticator 412, or additional components of service program 408 (not shown). In one embodiment, service program 408 maintains an audit trail or log of actions performed are stored in database 402. In one embodiment, the audit trail or log can be accessed throughout the execution process.

In step 508, service program 408 authenticates the request. In one embodiment, service program 408 sends the request to authenticator 412. Authenticator 412 receives the request and perform an authentication and/or authorization (as performed in step 502) on the request to make sure the information regarding the request is correct by comparing the information in the request against the user and account resources which were created when the request was first created. In one embodiment, authenticator 412 performs the authentication or authorization on specific requests which service program 408, service provider computing device 416, or a third party identifies as requiring a second authentication or authorization.

In step 510 service program 408 executes the request. In one embodiment, service program 408 uses handler 424 to execute the request. Service program 408 compiles the information from auditor function 410, authenticator 412, service provider computing device 416, and cloud marketplace 428 and determines which handler 424 should execute the request. In one embodiment, service program 408 selects which handler 424 should execute based on account ID component 414.

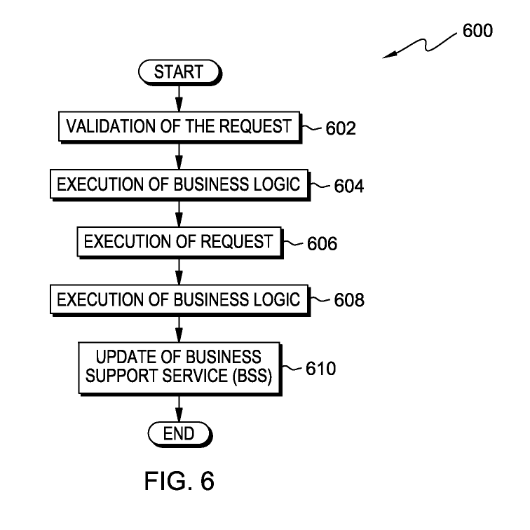

FIG. 6 depicts a flowchart 600 of the steps of handler 424 executing a request received by service program 408 within computing environment 100 of FIG. 1, in accordance with an embodiment of the present invention. Flowchart 600 depicts the validation, executing and updating of a request received by handler 424.

In step 602 handler 424 validates the request. Handler 424 validates the request to determine if the request meets the requirements from the authentication and/or authorization which was performed prior to handler 424 receiving the request. Handler 424 uses information from account ID component 414 to confirm the request is the correct request and there are no errors or issues with the request. If there are issues with the validation process, handler 424 sends the request back to service program 408 to contact one or more of service provider computing device 416, cloud marketplace 428, auditor function 410, and authenticator 412 to determine what caused the error. Handler 424 validates the request to confirm the request is paired with the proper handler 424 operation to execute the request.

In step 604 handler 424 executes business logic in response to the request. Business logic is how the request can be responded to by creating, displaying, storing, changing, and additional forms of modification to the request. Business logic enforces the routes and methods by which business objects are accessed and updated. In one embodiment, business logic includes the process of workflow. Workflow is the ordered tasks of passing documents, data, or requests from one participant to another. In one embodiment, participants include, but are not limited to, user computing device 418, service provider computing device 416, or computing device 426.

In step 606 handler 424 executes the request. The execution is specific to the request and the steps or procedures the request requires to be completed. Each request requires a specific set of requirements to properly execute the request. Handler 424 accesses service program 408, auditor function 410, authenticator 412, account ID component 414, or database 420 to determine the proper requirements, and resources which are needed to execute the request. In one embodiment, handler requires permission to execute the request from service program 408, service provider computing device 416, or computing device 426.

In step 608 handler 424 executes business logic after executing the request. Business logic enforces the routes and methods by which business objects are accessed and updated. In one embodiment, business logic includes the process of workflow. Workflow is the ordered tasks of passing documents, data, or requests from one participant to another. In one embodiment, participants include, but are not limited to, user computing device 418, service provider computing device 416, cloud marketplace 428, or computing device 426. In other embodiments, handler 424 determines if executing the business logic is necessary to repeat the execution of business logic. If executing the business logic is necessary to repeat the execution of business logic, handler 424 executes the commands. If executing the business logic is not necessary to repeat the execution of business logic, handler 424 skips the execution of business logic to increase the speed of the process.

In step 610 handler 424 updates BSS 422. Once handler 424 completes the necessary tasked to complete the execution of the request. Handler 424 communicates the information regarding the request to BSS 422. In one embodiment, handler 424 updates BSS 422, when there are inconsistencies between the information within BSS 422 and handler 424. In other embodiments, handler 424 sends the information to BSS 422 even if there are no inconsistencies between handler 424 and BSS 422. In one embodiment, handler 424 needs approval from service program 408, authenticator 412, account ID component 414, auditor function 410, BBS computing device 422, or service provider computing device 416 before updating BSS 422.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

In another embodiment, the invention provides a method that performs the process of the invention on a subscription, advertising, and/or fee basis. That is, a service provider, such as a Solution Integrator, could offer to provide a process for creating a standard and secure method of presenting products to consumers. In this case, the service provider can create, maintain, support, etc., a computer infrastructure, such as cloud computing environment 300 (FIG. 3) that performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for providing a process for creating a standard and secure method of presenting products to consumers. In this case, a computer infrastructure, such as cloud computing environment 200 (FIG. 2) can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as cloud computing environment 200 (FIG. 2), from a computer readable medium; (2) adding one or more computing devices to the computer infrastructure; and (3) incorporating and/or modifying one or more existing systems of the computer infrastructure to enable the computer infrastructure to perform the processes of the invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device which can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or additional freely propagating electromagnetic waves, electromagnetic waves propagating through a waveguide or additional transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

In another embodiment, the invention provides a method which performs the process of the invention on a subscription, advertising, and/or fee basis. That is, a service provider, such as a Solution Integrator, could offer to provide management services in a cloud computing service marketplace. In this case, the service provider can create, maintain, support, etc., a computer infrastructure, such as computer system 12 (FIG. 1) which performs the processes of the invention for one or more consumers. In return, the service provider can receive payment from the consumer(s) under a subscription and/or fee agreement and/or the service provider can receive payment from the sale of advertising content to one or more third parties.

In still another embodiment, the invention provides a computer-implemented method for managing services in a cloud computing service marketplace. In this case, a computer infrastructure, such as computer system 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system 12 (FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or additional programmable data processing apparatus to produce a machine, such that the instructions, which execute via the processor of the computer or additional programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or additional devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for managing services in a cloud computing service marketplace, the method comprising:
receiving, by one or more processors, a request for a service offered within a cloud computing service marketplace;
validating, by one or more processors, the request to confirm the service is offered within the cloud computing service marketplace;
applying, by one or more processors, a marker to the request, wherein the marker enables the request to be tracked;
validating, by one or more processors, the request to confirm that a sender of the request corresponds to a user account;
selecting, by one or more processors, a handler from a set of one or more handlers to execute the request based on the request for the service and the service being offered by the cloud computing service marketplace, wherein the handler is capable of executing a business logic technique; and
executing, by one or more processors, the business logic technique for the request using the handler.

2. The method of claim 1, further comprising:
updating, by one or more processors, a business support service with a quantity of information from the execution of the request by the handler.

3. The method of claim 2, wherein the cloud computing service marketplace comprises a catalog of pre-defined common micro-services implemented as static images to provision services.

4. The method of claim 1, further comprising:
responsive to confirming that the service is not offered within the cloud computing service marketplace, generating, by one or more processors, an error.

5. The method of claim 1, further comprising:
managing, by one or more processors, a quantity of provisioned resources to ensure ongoing fulfillment of the request.

6. The method of claim 5, further comprising:
monitoring, by one or more processors, the quantity of provisioned resources according to predefined policies of the service; and
managing, by one or more processors, the quantity of provisioned resources in conformance with the predefined policies of the service.

7. The method of claim 1, further comprising:
logging, by one or more processors, actions performed on the request.

8. A computer program product for managing services in a cloud computing service marketplace, the computer product comprising:
One or more computer readable storage media and program instructions stored on the one or more computer readable storage media, the program instructions comprising:
program instructions to receive a request for a service offered within a cloud computing service marketplace;
program instructions to validate the request to confirm the service is offered within the cloud computing service marketplace;
program instructions to apply a marker to the request, wherein the marker enables the request to be tracked;
program instructions to validate the request to confirm that a sender of the request corresponds to a user account;
program instructions to select a handler from a set of one or more handlers to execute the request based on the request for the service and the service being offered by the cloud computing service marketplace, wherein the handler is capable of executing a business logic technique; and
program instructions to execute the business logic technique for the request using the handler.

9. The computer program product of claim 8, further comprising:
program instructions, stored on the one or more computer readable storage media, to update a business support service with a quantity of information from the execution of the request by the handler.

10. The computer program product of claim 9, wherein the cloud computing service marketplace comprises a catalog of pre-defined common micro-services implemented as static images to provision services.

11. The computer program product of claim 8, further comprising:
program instructions, stored on the one or more computer readable storage media, to respond to confirming that the service is not offered within the cloud computing service marketplace, generating, by one or more processors, an error.

12. The computer program product of claim 8, further comprising:
program instructions, stored on the one or more computer readable storage media, to manage a quantity of provisioned resources to ensure ongoing fulfillment of the request.

13. The computer program product of claim 12, further comprising:
program instructions, stored on the one or more computer readable storage media, to monitor the quantity of provisioned resources according to predefined policies of the service; and
program instructions, stored on the one or more computer readable storage media, to manage the quantity of provisioned resources in conformance with the predefined policies of the service.

14. The computer program product of claim 8, further comprising:
program instructions, stored on the one or more computer readable storage media, to log actions performed on the request.

15. A computer system for managing services in a cloud computing service marketplace, the computer product comprising:
one or more computer processors, one or more computer readable storage media, and program instructions stored on the one or more computer readable storage media for execution by at least one of the one or more processors, the computer instructions comprising:
program instructions to receive a request for a service offered within a cloud computing service marketplace;
program instructions to validate the request to confirm the service is offered within the cloud computing service marketplace;
program instructions to apply a marker to the request, wherein the marker enables the request to be tracked;
program instructions to validate the request to confirm that a sender of the request corresponds to a user account;
program instructions to select a handler from a set of one or more handlers to execute the request based on the request for the service and the service being offered by the cloud computing service marketplace, wherein the handler is capable of executing a business logic technique; and
program instructions to execute the business logic technique for the request using the handler.

16. The computer system of claim 15, further comprising:
program instructions, stored on the one or more computer readable storage media for execution by at least one of the one or more processors, to update a business support service with a quantity of information from the execution of the request by the handler.

17. The computer system of claim 16, wherein the cloud computing service marketplace comprises a catalog of pre-defined common micro-services implemented as static images to provision services.

18. The computer system of claim 15, further comprising:
program instructions, stored on the one or more computer readable storage media for execution by at least one of the one or more processors, to respond to confirming that the service is not offered within the cloud computing service marketplace, generating, by one or more processors, an error.

19. The computer system of claim 15, further comprising:
program instructions, stored on the one or more computer readable storage media for execution by at least one of the one or more processors, to manage a quantity of provisioned resources to ensure ongoing fulfillment of the request.

20. The computer system of claim 19, further comprising:
program instructions, stored on the one or more computer readable storage media for execution by at least one of the one or more processors, to monitor the quantity of provisioned resources according to predefined policies of the service; and
program instructions, stored on the one or more computer readable storage media for execution by at least one of the one or more processors, to manage the quantity of provisioned resources in conformance with the predefined policies of the service.
